(19) United States
(12) Patent Application Publication
(10) Pub. No.: US 2007/0060089 A1
(43) Pub. Date: Mar. 15, 2007

(54) Wi-Fi network locator with directional antenna and wireless adaptor

(76) Inventors: James Owen, Irvine, CA (US); Burch Driver, Pasadena, CA (US)

Correspondence Address: PHILIP K. YU, 20955 PATHFINDER ROAD, SUITE 100, DIAMOND BAR, CA, 91765, US

(21) Appl. No.: 11/225,714

(22) Filed: Sep. 12, 2005

(51) Int. Cl. H04B 1/16

(52) U.S. Cl. 455/229; 455/227

(57) ABSTRACT

A wireless network locator device with a directional antenna and network adaptor. When the directional antenna is deployed, it allows the users to pinpoint the source of the RF signals. The network locator also has a network adaptor circuit to allow the users to readily connect to the RF source, using the same locator device. The network adaptor can be connected to the laptop through its USB connector, which also allows the locator device to re-charge itself when connected.

### RELATED FIELD

The present invention relates to wireless local area network and more particularly relates to a wireless signal locator device for locating wireless local area network, commonly known as the “Wi-Fi”, wireless LAN or WLAN network.

### ART BACKGROUND

The demand for wireless communications has seen tremendous growth in recent years. Indeed, wireless communication technology is used every day by many people around the world to exchange information using pagers, cellular telephones, wireless personal digital assistants, and other wireless communication products. Recently, the advent in wireless communication technologies has carried over to business and personal computing. Wireless communication technology now permits computer users to access and share information and data, without being tethered by a physical wire to a computer network infrastructure traditionally used to connect computing devices. A common wireless communication network is the wireless fidelity, known as the “Wi-Fi” local area network, or the wireless LAN.

Typically, a mobile computer user is advised of the presence of a wireless LAN by the printed signs posted by the proprietor of the facility, e.g. at the Starbucks® cafe. Or the mobile computer can turn on his portable computing device, which is equipped with a wireless antenna, to see if the connection is there. However, the signs cannot cover all the areas. And the process of unpacking the notebook computer, powering it up and checking for a “hot spot” turns out to be quite burdensome. As such, a Wi-Fi network locator was developed, which is essentially an antenna with some filtering circuits. The locator allows the user to move around to determine the scope and strength of the wireless network. U.S. Pat. No. 5,949,379, issued to Yang, entitled MICROWAVE ANTENNA DEVICE ON PCMCIA NETWORK CARDS FOR NOTEBOOK COMPUTERS, discloses one exemplary microwave antenna. The entire disclosure of the Yang patent is incorporated herewith by reference.

When Wi-Fi network locators first arrived on the market, they used omni-directional antennas. This allowed the users to locate Wi-Fi signals in the area, but the users were unable to determine where the signal was coming from. Because the omni-directional antennas received signals in a circular pattern (with the device being at the center of the circle), the signal read-out, in theory, would be equally strong, without respect to direction, so long as the device was anywhere within the radius of that circle. However, such locators fail to inform the users as to the source of the RF signals, thus preventing the users from achieving optimal reception. Such locators simply locate a signal within the vicinity of their reception range, and nothing more. U.S. Patent Application Publication No. US 2004/0132446, filed by Seedman, et al., entitled METHOD AND APPARATUS FOR DETECTING THE PRESENCE OF A WIRELESS NETWORK, discloses one exemplary wireless network locator using omni-directional antennas. The entire disclosure of the Seedman application is incorporated herewith by reference.

Also, once a wireless network is located, the users still must use a network adaptor to connect the computing devices to the wireless network. A wireless network adapter is similar to a wired network adapter in that it permits a computing device to send and receive data from external sources. A wireless adapter may be installed as an adapter card, or in an adapter slot such as a universal serial bus (USB) slot. A wireless adapter typically consists of two major portions: a radio portion and a baseband portion. U.S. Pat. No. 6,544,075, issued to Liao, entitled WIRELESS ADAPTER, discloses one exemplary wireless adaptor. The entire disclosure of the Liao patent is incorporated herewith by reference.

Despite the development in network locator technology using omni-directional antennas, it still fails to allow the users to pinpoint the source of the RF signals. It also fails to help the users obtain the optimal reception and to provide a ready connection to the signal source.

### SUMMARY OF THE INVENTION

A wireless network locator device with a directional antenna is disclosed. When the directional antenna is deployed, it allows the users to pinpoint the source of the RF signals. The network locator also has a network adaptor circuit to allow the users to readily connect to the RF source, using the same locator device. The network adaptor can be connected to the laptop through its USB connector, which also allows the locator device to re-charge itself when connected.

In one embodiment, the directional antenna is implemented in a first housing, which can be propped up from the horizontal base housing of the locator device. The first housing is rotatably connected to the base housing to allow the antenna to rotate 180 degrees clockwise and counterclockwise.

### BRIEF DESCRIPTION OF THE DRAWINGS

FIG. 1 illustrates an exemplary wireless network locator device with a network adaptor in accordance with the present invention.

FIGS. 2(a) and 2(b) illustrate an exemplary wireless network locator device in another embodiment.

FIG. 3 illustrates a simplified system diagram of an exemplary Wi-Fi locator in accordance with the present invention.

FIG. 4 illustrates a simplified process flow for an exemplary Wi-Fi detection scheme in accordance with the present invention.

FIGS. 5(a)-(c) illustrate an exemplary wireless network locator device with network adaptor.

### DETAILED DESCRIPTION OF THE PREFERRED EMBODIMENT

A wireless network locator with a directional antenna is disclosed. In the following detailed description, numerous specific details are set forth to provide a full understanding of the present invention. It will be obvious, however, to one ordinarily skilled in the art that the present invention may be practiced without some of these specific details. In other instances, well-known structures and techniques have not been shown in detail so as to avoid unnecessarily obscuring the present invention. While the present invention is described in the context of a Wi-Fi network, it should be apparent to those skilled in the art that the present invention is not limited to only IEEE 802.11 a/b/g locator and network adaptor designs.

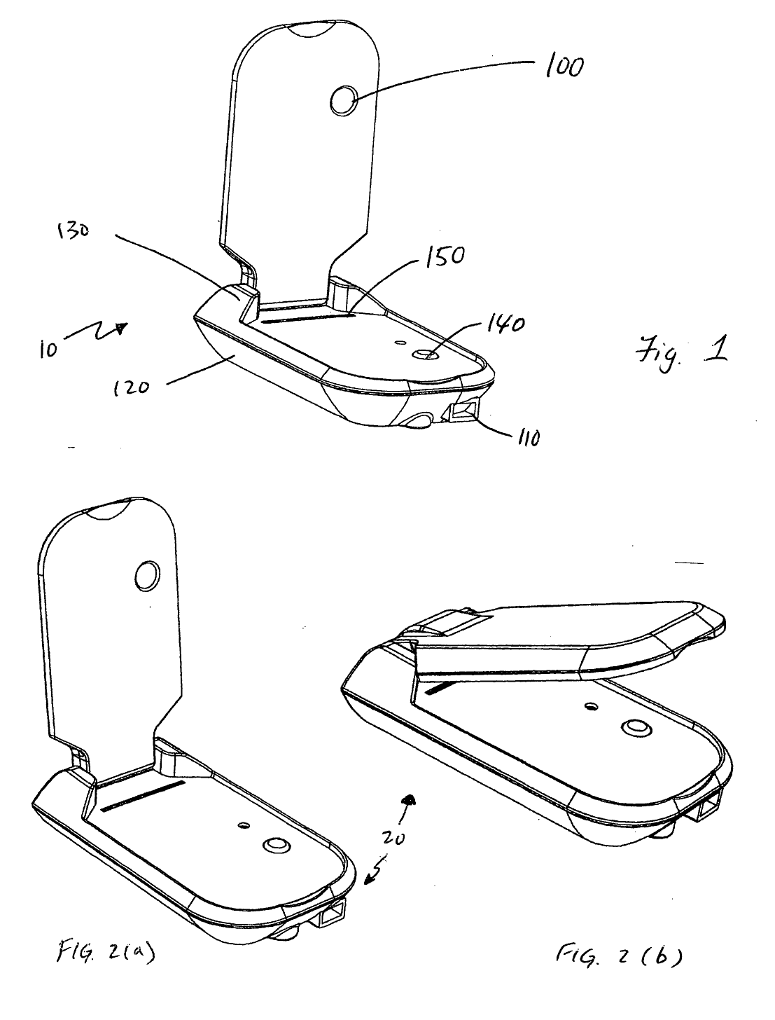

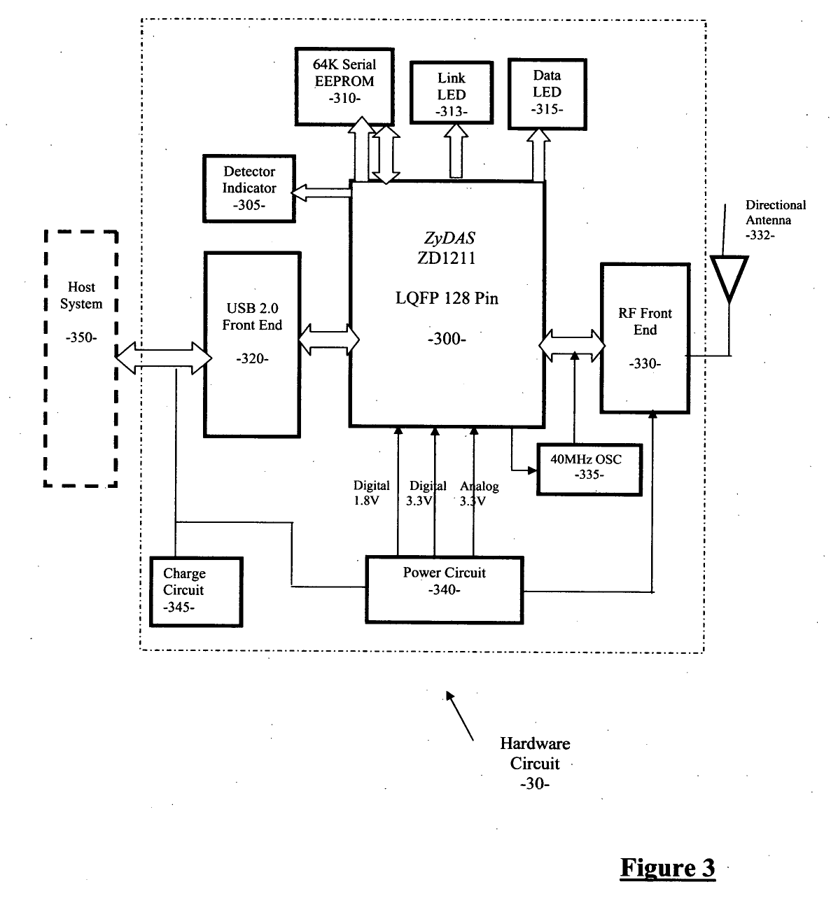

Reference is first turned to FIGS. 1, 2(a) and 2(b), where an exemplary locator device with a flip-up directional antenna is shown. As shown in FIG. 1, the locator 10 has a base housing 120 for housing the electronic components and a USB connector 110, and a flip-up directional antenna panel 100 on the propped up housing. By using the term “directional antenna” in the present application, it is intended to refer to an antenna that is not omni-directional, such as unidirectional, bi-directional, 90-degree or “front and back.” A “locate” button 140 and a LED readout 150 are positioned on the base housing 120 to provide user control and read-out. The flip-up antenna panel 100 is connected to the base housing 120 through a hinge 130, so that the antenna 100 can be folded down when not in use, or propped up about 90 degrees from the base housing 120 in deployment. This “flip-up” feature is also commonly referred to as the “clam shell” form factor for mobile phones and portable electronic devices. FIGS. 2(a) and 2(b) show the locator 20, which does not have a USB connector and can only function as a Wi-Fi signal locator, in propped-up and folded-down positions, respectively. As can be appreciated by those skilled in the art, the “clam-shell” form factor provides more portability and protection.

With the directional antenna panel 100, preferably one with high gain (e.g. >2 db in passive antenna peak power), the locator 10 allows the users to determine the location of the RF source, in contrast to just locating a signal within the vicinity of a conventional locator's receiving range. Thus, the LED readout 150 provides a strength-of-signal readout according to the orientation of the directional antenna 100. Implemented with the network, adaptor 110, the locator 10 allows the users to plug their laptop or PDA (not shown) to the locator 10 and begin accessing the wireless network. The USB port 110 further allows the internal battery (not shown) of the locator 10 to recharge through the laptop.

It should be noted that the USB port 110 may be connected to the laptop's USB port, through a USB cable. As such, while the user can position, or orient, the locator 10 so that its directional antenna points directly toward the RF source, the user does not need to re-position the laptop. Additionally, the directional antenna panel 100 may be connected to the base housing 120 through a rotational hinge, a pivot, a ball-joint connector or a universal hinge, so that the directional antenna panel 100 may be rotated relative to the horizontal plane of the base housing 120. With such implementation, the locator's USB network adaptor 110 may be designed so that the USB connector 110 directly plugs into the laptop's USB port, if the laptop port is conveniently located on the laptop. For example, such pivoting and rotational designs are disclosed by the aforementioned Yang patent and Liao patent, which have been incorporated herein by reference.

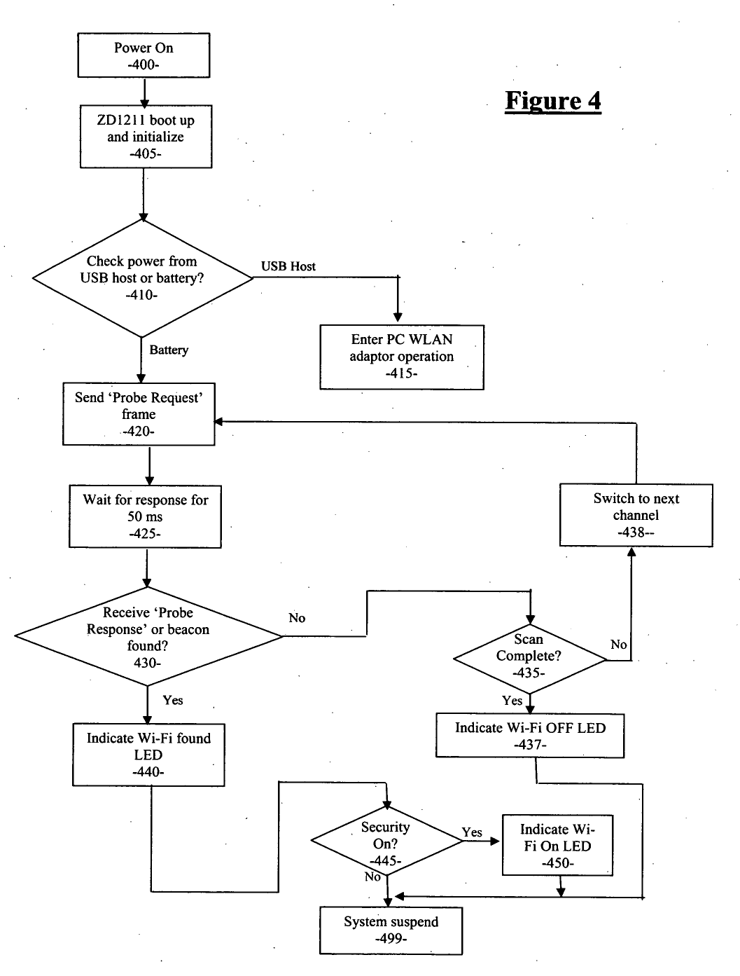

Reference is now to FIG. 3, where a simplified system diagram of the exemplary Wi-Fi locator with a network adaptor is illustrated. The basic components of the system include an RF receiver, signal filters and a high-gain directional antenna. As shown in FIG. 3, the exemplary hardware circuit 30 has a Wi-Fi chip set based on a processor 300 from ZyDAS Corporation of Taiwan, namely ZD1211. The RF front end 330 provides RF radio functionality, in conjunction with the directional antenna 332, which may be the kind with high-gain (5 dBi). Clocking is provided by a 40 MHz oscillator 335. The Link and Data LEDs 313, 315 and detection indicator 305 provide a visual indication of the locator's status to the user. The EEPROM 310 stores the code that operates the processor 300. The power circuit 340 and charge circuit 345 provide appropriate voltages to the processor's analog and digital operations. As mentioned above, the locator 10 can recharge itself through the charge circuit 345, when it is connected to a host system 350, through the USB front end 320.

As can be appreciated by those skilled in the art, if the locator only serves as a Wi-Fi locator without the network adaptor, such as the locator 20 shown in FIG. 2, analog filters can be readily implemented to do the signal detection. However, when the network adaptor functionality is provisioned, the wireless chip set can be set up to provide the signal detection, thus obviating the need for analog filters. Additionally, the aforementioned Seedman patent, which has been incorporated herein by reference, provides another exemplary wireless locator design, although the Seedman device does not teach the use of a flip-up directional antenna. Nor does it teach the full network adaptor functionality provided by the locator 10 in accordance with the present invention.

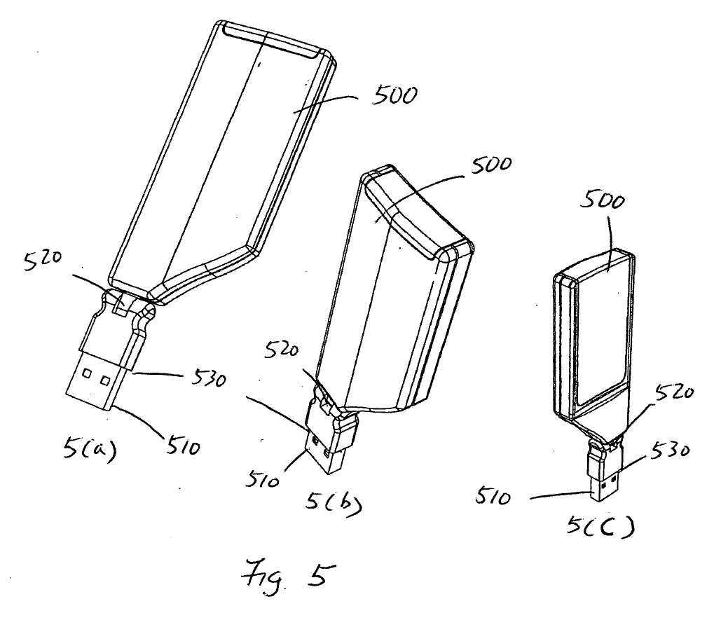

Reference is now to FIG. 4, where a simplified process flow for the exemplary Wi-Fi detection scheme is illustrated. At steps 400 and 405, the locator is powered on, and the ZD1211 processor boots up and performs initialization. At step 410, it checks if it is already connected to the host system 350 through its USB port 320, and if so, it enters the PC WLAN adaptor operation (step 415), since the locator is already connected to the laptop.

If the power comes from the battery, i.e. the locator is not plugged into the laptop, the locator is to detect the presence of a wireless network by sending out a “Probe Request” frame (step 420) when the user presses the LOCATE button on the device.

After waiting for about 50 ms (step 425), it determines if a “Probe Response” is received from an access point (“AP”), or a beacon found (step 430). If not found, then the locator determines if scanning is completed (step 435). If not completed, the locator switches to another channel (step 438) and repeats the sending of “Probe Request” at step 420. If scanning is already completed without receiving any “Probe Response” or finding any beacon, then the “Wi-Fi OFF” LED is turned on (step 437) and the system is suspended (step 499).

If the “Probe Response” is received from the AP, or the beacon is found, it indicates a Wi-Fi network is located by turning on the LED (step 440). The locator then checks if the security is on (step 445) and if so, the “Wi-Fi ON” LED is turned on and the scanning system is suspended (step 499). If the security is not on, the scanning system is still suspended (step 499).

The Wi-Fi locator in accordance with the present invention is advantageous over the conventional locator in several aspects. First, the Wi-Fi locator 10 is provisioned with a high-speed wireless-G USB 2.0 network adaptor as well as the ability to differentiate wireless networks with security enabled. The Wi-Fi adaptor allows the users to detect an 802.11b, 802.11g or other wireless signal and effortlessly connect to that signal by attaching their laptop or desktop directly to the locator via the USB 2.0 port. The burden of having to first power up the laptop and connect to wireless “hot spots” is now significantly reduced. The users simply push the “LOCATE” button 140 to detect the network, and connect to the network from the locator directly.

The high-gain directional antenna 332 also provides two important functions: 1) upon detecting wireless networks, the high-gain directional antenna helps the users determine exactly where the source of the wireless network is, by showing signals of varying strength at different angles, and 2) when connecting to a wireless network, the high-gain directional antenna guarantees the strongest link possible and provides greater distance than conventional wireless network adaptors due to its advanced 5 dBi antenna. Finally, the locator automatically recharges its internal battery whenever it is connected to a laptop through the USB connector.

In addition, the Wi-Fi locator in accordance with the present invention may be implemented with a LCD and/or LED display so as to provide better user interface about the status and the connection. An exemplary simplified block diagram is shown in FIG. 6. The use of a hardware circuit (illustrated in FIG. 3, block 30) from ZYDAS 610 is only for illustration purposes, while those skilled in the art can readily determine their preferred chipset based on their specification. Microcontroller 630 takes the signals from the hardware circuit 610 and drives the LCM 620 using power 640.

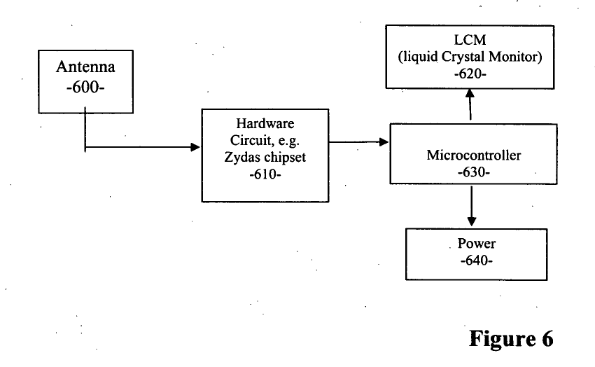

In another embodiment, the high-gain directional antenna is one that is embedded with the circuitry so that they can both be implemented in one housing, which is further connectable to the laptop through USB dongle, as shown in FIG. 5(a)-(c). The housing 500 contains both the embedded high-gain directional antenna and the necessary circuitry. A universal joint or hinge 520 may provide rotation about one axis at hinge 520, or about another axis at hinge 530. The USB connection 510 is readily connected to the USB on the computer or portable device.

Although the invention is described herein with reference to the preferred embodiment, one skilled in the art will readily appreciate that other applications may be substituted for those set forth herein without departing from the scope of the present invention. Accordingly, the invention should only be limited by the claims included below.

We claim:

1. A wireless network locator for an electronic device, comprising:
a first housing;
a base housing, said first housing being hingedly connected to said base housing, forming a clam-shell form factor;
a directional antenna, said directional antenna being implemented within said first housing, said directional antenna being disposed to receive a predetermined wireless signal in a directional manner;
a wireless signal locator operatively coupled to said directional antenna, said locator being disposed to detect the presence of a wireless network based on the received wireless signal from said directional antenna.

2. The wireless network locator of claim 1, wherein said predetermined wireless signal is at least one of IEEE 802.11x Wi-Fi, WIMAX, UWB, RFID, Bluetooth, 3G and WCDMA.

3. The wireless network locator of claim 1, wherein said first housing is hingedly connected to said base housing through a universal hinge capable of rotating relative to said base housing.

4. The wireless network locator of claim 1, wherein said first housing is hingedly connected to said base housing through a hinge capable of controllably rotating in at least one axis relative to said base housing.

5. The wireless network locator of claim 1, further comprising:
a network adaptor operatively connected to said directional antenna, said network adaptor being controllably providing communication between said electronic device and said wireless network, said network adaptor being implemented at least partially within said base housing.

6. The wireless network locator of claim 5, further comprising:
a data connecting assembly implemented on said second housing, said data connecting assembly being detachably connected to said electronic device.

7. The wireless network locator of claim 6, further comprising a recharge circuit for recharging itself when said data connecting assembly is connected to said electronic device.

8. The wireless network locator of claim 6, wherein said data connecting assembly is compliant with one of IEEE 1394 and USB communications standards.

9. The wireless network locator of claim 5, wherein said network adaptor is disposed to detect if data security is enabled by said wireless network.

10. The wireless network locator of claim 5, further comprising a LCD display, said LCD display being disposed to display connection status information.

11. The wireless network locator of claim 10, wherein said directional antenna is a high-gain antenna with >2 dB in passive antenna peak power.

12. A wireless network locator for an electronic device, comprising:
a first housing;
a base housing, said first housing being hingedly connected to said base housing, forming a clam-shell form factor, wherein said first housing is coupled to said base housing through a hinge capable of rotating in a vertical axis relative to said base housing;
a directional antenna, said directional antenna being implemented within said first housing, said directional antenna being disposed to receive a predetermined wireless signal in a directional manner;
a wireless signal locator operatively coupled to said directional antenna, said locator being disposed to detect the presence of a wireless network based on the received wireless signal from said directional antenna;
a network adaptor operatively coupled to said directional antenna, said network adaptor being controllably providing communication between said electronic device and said wireless network, said network adaptor being implemented at least partially within said base housing;
a data connecting assembly implemented on said second housing, said data connecting assembly being detachably connected to said electronic device.

13. The wireless network locator of claim 12, wherein said data connecting assembly is compliant with one of IEEE 1394 and USB standards.

14. The wireless network locator of claim 12, wherein said predetermined wireless signal is at least one of Wi-Fi, WIMAX, UWB, RFID, Bluetooth, 3G and WCDMA.

15. The wireless network locator of claim 13, wherein said directional antenna is a high-gain directional antenna with >2 db in passive antenna peak power.

16. The wireless network locator of claim 13, further comprising a re-charge circuit for recharging itself when said data connecting assembly is connected to said electronic device.

17. The wireless network locator of claim 16, further comprising a battery unit disposed within said base housing.

18. The wireless network locator of claim 12, wherein said network adaptor is disposed to detect if security is enabled by said wireless network.

19. A handheld mobile device for locating and connecting to a wireless signal source, comprising:
a housing;
a high-gain directional antenna, said directional antenna being embedded within said housing and disposed to receive a predetermined wireless signal from said wireless signal source in a directional manner;
a wireless signal locator operatively connected to said directional antenna, being disposed to detect the presence of a wireless network based on the received wireless signal from said directional antenna.

20. The handheld mobile device of claim 19, further comprising:
a network adaptor operatively connected to said directional antenna in said housing, being disposed to provide communication for said handheld mobile device.

21. The handheld mobile device of claim 20, further comprising:
a data connecting assembly connected to said housing for providing physical connection for said communication through a universal ball joint.
